(19) United States
(12) Patent Application Publication
(10) Pub. No.: US 2015/0058321 A1
(43) Pub. Date: Feb. 26, 2015

(54) SYSTEM FOR RECOMMENDING RESEARCH-TARGETED DOCUMENTS, METHOD FOR RECOMMENDING RESEARCH-TARGETED DOCUMENTS, AND PROGRAM

(71) Applicant: Hitachi, Ltd., Tokyo (JP)

(72) Inventor: Masataka Tanaka, Tokyo (JP)

(73) Assignee: Hitachi, Ltd., Tokyo (JP)

(21) Appl. No.: 14/390,084

(22) PCT Filed: Apr. 2, 2013
(86) PCT No.: PCT/JP2013/060023

§ 371 Date: Oct. 2, 2014

(30) Foreign Application Priority Data
Apr. 4, 2012 (JP) 2012-085783

(51) Int. Cl. G06F 17/30; G06F 17/22

(52) U.S. Cl. CPC G06F 17/30112; G06F 17/2276
USPC 707/722

(57) ABSTRACT

Information regarding a specific field, such as use information of a substance subject to regulation, is collected from the Web and the like, and an investigation object document enabling efficient investigation while exhausting the information is provided. For this purpose, a use description range is extracted from document information acquired from the Web based on a search word, in which range the use of the substance subject to regulation is described. Then, based on use word dictionary information for managing a keyword regarding the use of the substance subject to regulation, use information regarding the substance subject to regulation is extracted from the use description range. Thereafter, from the document information acquired from the Web based on the search word, a set of documents providing a combination of a minimum number of documents exhausting all of the use information included in all of the documents is extracted as recommended documents. Finally, the extracted use information and the recommended documents are displayed.

### TECHNICAL FIELD

The present invention relates to systems for extracting a document including a specific keyword from the Web and the like. For example, the present invention relates to a system that collects information about a specific field (such as use information of a substance subject to regulation that is contained in a component) from the Web, and that enables efficient investigation while ensuring the exhaustiveness of the information.

### BACKGROUND ART

In recent years, environmental regulations by law have been reinforced in various countries. One example of the law is the Registration, Evaluation, Authorization, and Restriction of Chemicals (REACH) rule established in Europe. REACH is a regulation mandating the notification or transmittal of information of a substance subject to regulation contained in a product. In order to comply with such regulations, each corporation needs to investigate or examine information about the substance subject to regulation contained in procured components, and to report the information to clients.

However, the substances subject to regulation by the environmental regulations are successively added. Thus, if the investigation or examination is performed every time a substance subject to regulation is added, the man-hour or cost for the entire procured components becomes huge. Accordingly, it is necessary to perform the investigation or examination preferentially from those components having a higher probability of containing a substance subject to regulation. One method for such prioritization involves the use of use information (such as the function obtained through the addition of the substance, or the material in which the substance is used) of the substance subject to regulation. Generally, the use information is investigated by searching the Web, for example. However, on the Web and the like, the same use information may be redundantly described in a plurality of documents, making it necessary to spend much time in collecting the necessary use information.

Patent Literature 1 describes a method for extracting from the Web and the like a document having a keyword such as the use information and the like of a substance subject to regulation that needs to be investigated. According to the method, information related to a specific subject is collected from the Web and the like, and the degree of exhaustiveness of the relevant information in an acquired document and the frequency of appearance of the relevant information in a yet-to-be-acquired document are displayed. According to this method, the documents can be rearranged and displayed in order of decreasing amount of yet-to-be-investigated information of the use information of a substance subject to regulation that needs to be investigated, enabling efficient investigation of the use information.

### CITATION LIST

### Patent Literature

Patent Literature 1: JP 2010-146345 A

### SUMMARY OF INVENTION

### Technical Problem

As described above, the method described in Patent Literature 1 enables rearrangement and display of documents in order of decreasing amount of use information that is yet to be investigated. However, it may not necessarily be the best to investigate the documents in the order of display. Namely, the number of investigated documents may not necessarily be minimized. Thus, the method described in Patent Literature 1 still has the problem that the time required for investigation is more than necessary.

The present invention relates to a system for extracting a document containing a specific keyword from the Web and the like, and provides a technology that enables the investigation of information as the object for extraction not just exhaustively but efficiently.

### Solution to Problem

In order to solve the above-described problem, the present inventors provide configurations described in the claims, for example. The present specification may include a plurality of inventions by which the problem is solved. For example, an embodiment provides an investigation object document recommendation system 10 which will be described below. The investigation object document recommendation system 10 includes: (a) an input/output unit 100 that acquires data necessary for a process and that displays a result of processing of the data; (b) a storage unit 200 including use word dictionary information 211 for managing a keyword regarding a use of a substance subject to regulation; and (c) an operating unit 300 that, based on a search word regarding the substance subject to regulation which is input via the input/output unit 100, acquires document information from the Web, and presents use information of the substance subject to regulation and a combination of documents that exhausts the use information. The operating unit 300 includes: (c-1) a document acquisition unit 321 that acquires the document information from the Web based on the search word; (c-2) a use description range extraction unit 322 that extracts from the acquired document information a range in which the use of the substance subject to regulation is described; (c-3) a use information extraction unit 323 that, based on the use word dictionary information 211, extracts the use information regarding the substance subject to regulation from the extracted use description range; (c-4) a recommended document determination unit 324 that, among all of the documents acquired by the document acquisition unit 321, extracts a set of documents providing a combination of a minimum number of documents that exhausts all of the use information extracted by the use information extraction unit 323, as recommended documents; and (c-5) a display control unit 325 that displays the use information extracted by the use information extraction unit 323 and the recommended document, on the input/output unit 100.

### Advantageous Effects of Invention

According to the present invention, the user can be presented with a combination of documents as the recommended documents that can exhaust all of the use information appearing in a set of documents containing the substance subject to regulation as a search word by the minimum number of documents. Thus, the man-hour for investigation of the use information for prioritizing components with a high probability of containing the substance subject to regulation can be decreased, whereby, as a whole, the man-hour and cost for investigation and examination of components containing the substance subject to regulation can be decreased. Other problems, configurations, and effects will become apparent from the following description of modes of implementation.

### BRIEF DESCRIPTION OF DRAWINGS

FIG. 1 illustrates a process flow according to Embodiment 1.

FIG. 2 is a block diagram of the configuration of an overall system according to Embodiment 1.

FIG. 3 illustrates an example of use word dictionary information according to Embodiment 1.

FIG. 4 illustrates an example of search word information according to Embodiment 1.

FIG. 5 illustrates an example of use information according to Embodiment 1.

FIG. 6 illustrates an example of document information according to Embodiment 1.

FIG. 7 illustrates an example of by-document use information according to Embodiment 1.

FIG. 8 illustrates an example of an input screen according to Embodiment 1.

FIG. 9 illustrates an example of intermediate data of the document information according to Embodiment 1.

FIG. 10 illustrates an example of a use description range extraction method in a case where document information is divided into chapters in HTML format.

FIG. 11 illustrates an example of the use description range extraction method in a case where the document information is divided into chapters and sections in HTML format.

FIG. 12 illustrates an example of the use description range extraction method in a case where the document information is described as a table in HTML format.

FIG. 13 illustrates an example of the use description range extraction method in a case where the document information is described as a list in HTML format.

FIG. 14 illustrates an example of the use description range extraction method in a case where the document information is described by sentences in HTML format.

FIG. 15 illustrates an example of a process flow of a use information extraction unit according to Embodiment 1.

FIG. 16 illustrates an example of an output screen according to Embodiment 1.

FIG. 17 illustrates a process flow according to Embodiment 2.

FIG. 18 is a block diagram of the configuration of an overall system according to Embodiment 2.

FIG. 19 illustrates an example of the use word dictionary information according to Embodiment 2.

FIG. 20 illustrates an example of the use information according to Embodiment 2.

FIG. 21 illustrates an example of the contained-in-component substance information according to Embodiment 2.

FIG. 22 illustrates an example of the by-use component information according to Embodiment 2.

FIG. 23 illustrates an example of the output screen according to Embodiment 2.

FIG. 24 illustrates an example of an output screen for displaying the by-use component information according to Embodiment 2.

FIG. 25 illustrates an example of the output screen for displaying a list of components subject to investigation according to Embodiment 2.

FIG. 26 illustrates a process flow according to Embodiment 3.

FIG. 27 is a block diagram of the configuration of an overall system according to Embodiment 3.

FIG. 28 illustrates an example of use information according to Embodiment 3.

FIG. 29 illustrates an example of component importance information according to Embodiment 3.

FIG. 30 illustrates an example of an output screen according to Embodiment 3.

FIG. 31 illustrates an example of an output screen for displaying by-use component information according to Embodiment 3.

### DESCRIPTION OF EMBODIMENTS

In the following, modes of implementation of the present invention will be described with reference to the drawings. The mode of implementation of the present invention is not limited to the following embodiments and may be variously modified within the scope of the technical concept of the present invention.

### Embodiment 1

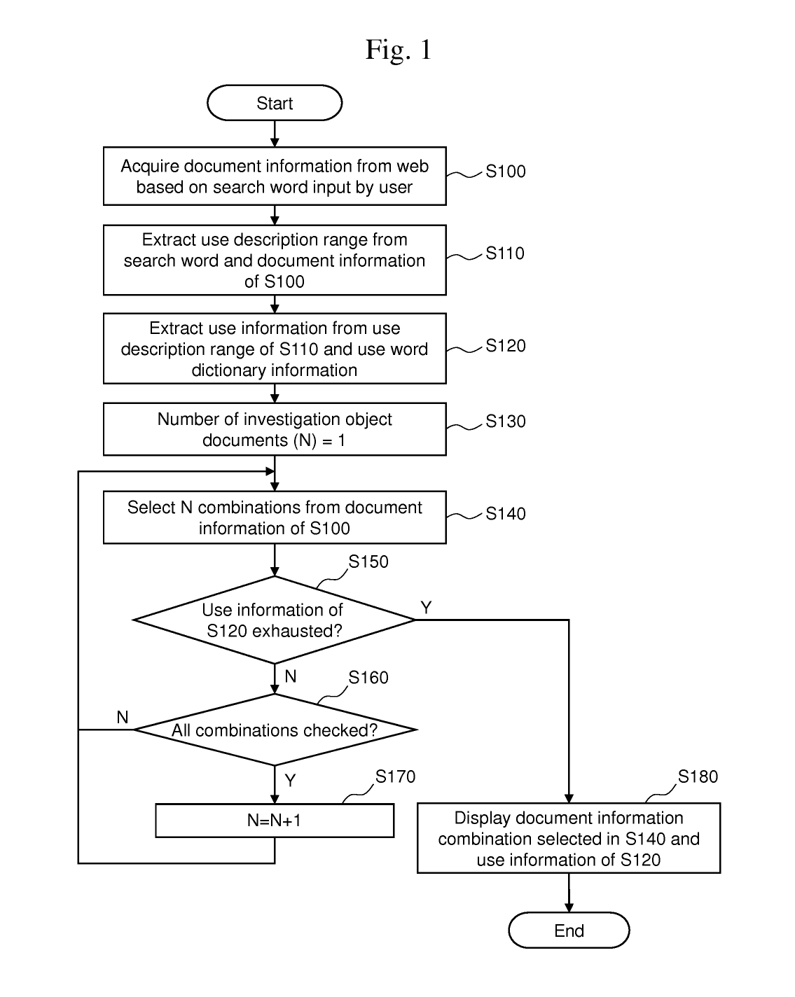

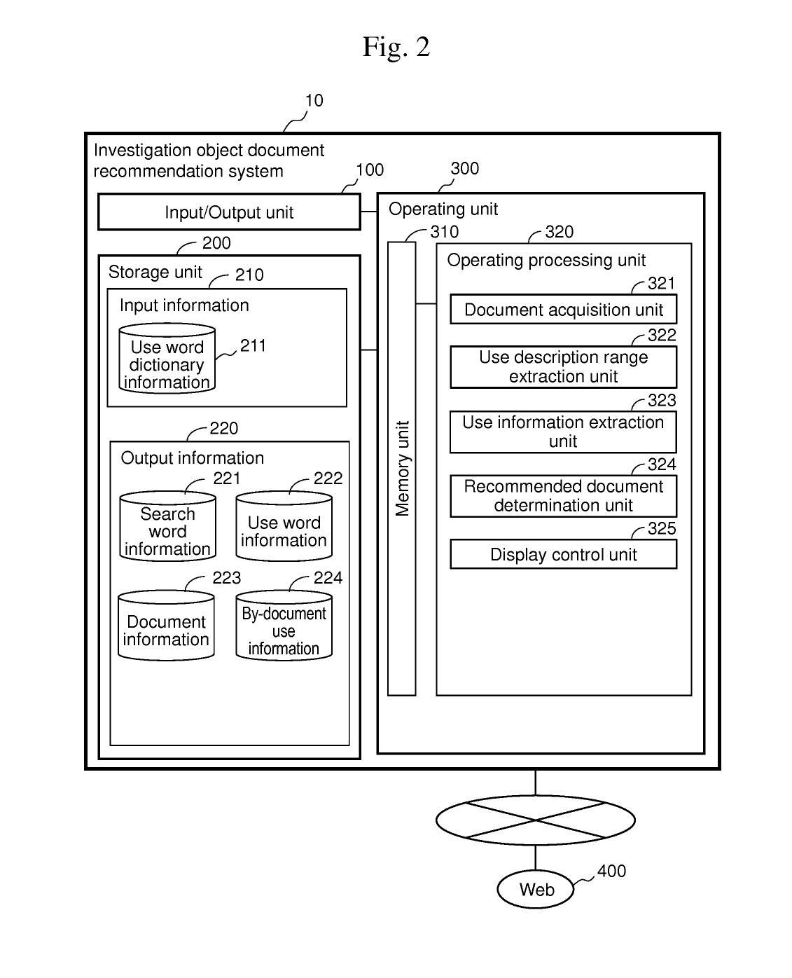

In the following, an investigation object document recommendation system according to the present embodiment will be described with reference to FIG. 1 and FIG. 2. FIG. 1 illustrates an example of the process flow according to the present embodiment. FIG. 2 is a functional block diagram of the system configuration of the present embodiment.

### System Configuration

In FIG. 2, the investigation object document recommendation system 10 may include a PC, such as a server or a terminal possessed by a service providing solution vendor or a user, or a system implemented in the PC. The investigation object document recommendation system 10 is provided with an input/output unit 100, a storage unit 200, and an operating unit 300.

The input/output unit 100 is used for acquiring data necessary for a process in the operating unit 300, and for displaying a processing result of the operating unit 300. The input/output unit 100 may include an input device such as a keyboard and mouse, a communication device for communication with the outside, a recording/reproduction device for a disk storage medium, and an output device such as a CRT or a liquid crystal monitor, for example.

The storage unit 200 stores input information 210 used by the process in the operating unit 300, and output information 220 that is the result of the process in the operating unit 300. The storage unit 200 may include a storage device such as a hard disk drive or a memory.

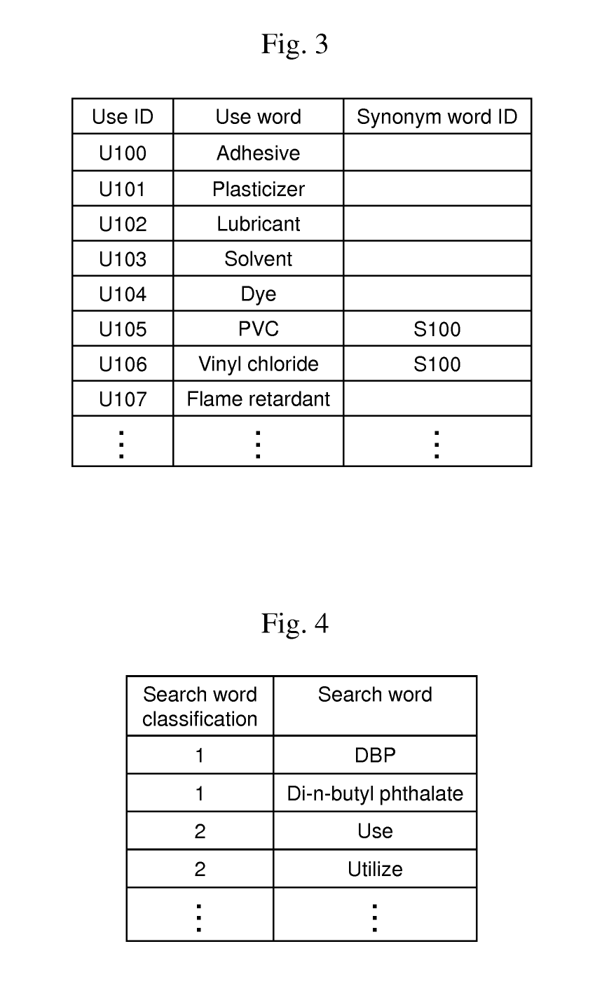

The input information 210 contains use word dictionary information 211. The use word dictionary information 211 includes information used for managing keywords regarding the use of a substance subject to regulation. FIG. 3 illustrates an example of the information constituting the use word dictionary information 211. The use word dictionary information 211 illustrated in FIG. 3 includes information about use IDs, use words, and synonym IDs. In the illustrated example, for the data with the use ID “U100”, “adhesive” is registered as the use word and a blank is registered as the synonym ID. The blank synonym ID indicates that there is no synonym for the use word “adhesive”. Thus, the synonym ID is used to manage the presence of other use words with similar meanings. For example, the use word “PVC” managed with the use ID “U105” and the use word “vinyl chloride” managed with the use ID “U106” are different from each other. However, both the use ID “U105” and the use ID “U106” are provided with the common synonym ID “S100”, indicating that the use words managed with these use IDs have similar meanings.

The output information 220 contains search word information 221, use information 222, document information 223, and by-document use information 224.

The search word information 221 includes information indicating a search keyword used when collecting the use information of a substance subject to regulation from the Web 400 and the like. FIG. 4 illustrates an example of the information constituting the search word information 221. The search word information 221 shown in FIG. 4 includes information about search word classification and search word. In FIG. 4, search word classifications “1” and“2” indicate that the corresponding search words are search keywords regarding a substance subject to regulation and use, respectively. For example, the search word “DBP” has the search word classification “1” and is therefore a keyword regarding a substance subject to regulation.

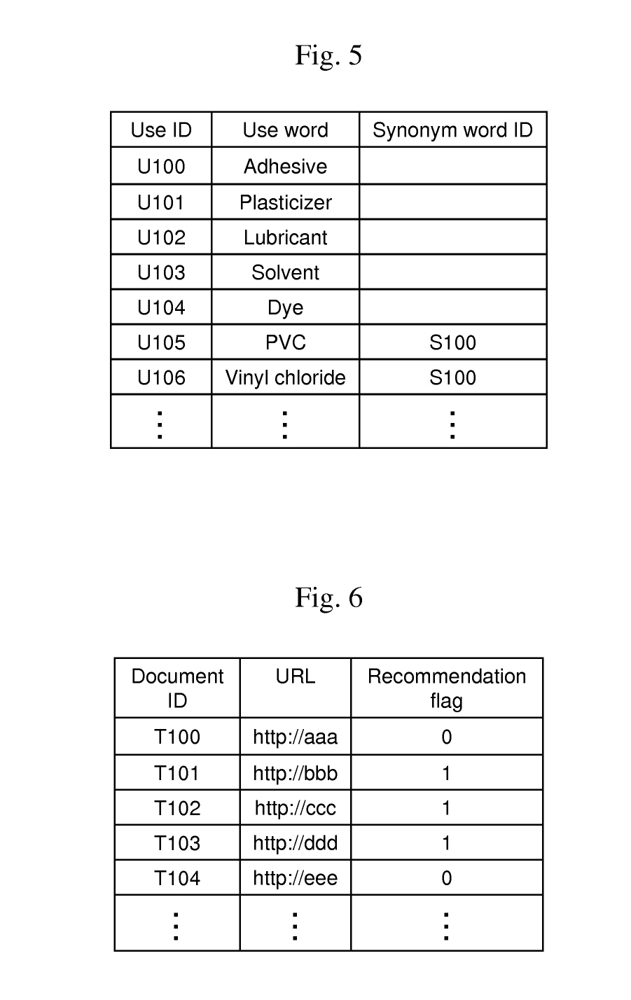

The use information 222 includes information for storing keywords regarding use of the substance subject to regulation extracted by a use information extraction unit 323 which will be described later. FIG. 5 illustrates an example of the information constituting the use information 222. The use information 222 of FIG. 5 includes information regarding use IDs, use words, and synonym IDs. The data structure of the use information 222 illustrated in FIG. 5 is similar to that of the use word dictionary information 211, and therefore a description of the structure will be omitted.

The document information 223 includes information of documents acquired by a document acquisition unit 321 and recommended documents determined by a recommended document determination unit 324, which units will be described later. FIG. 6 illustrates an example of the information constituting the document information 223. The document information 223 illustrated in FIG. 6 includes information regarding document ID, Uniform Resource Locator (URL), and recommendation flag. The recommendation flag is information indicating whether, when the use information of a substance subject to regulation is investigated, a document has been extracted as a document recommend by the present system. The recommended documents are indicated by “1”. Thus, in the case of FIG. 6, the three documents managed with the document IDs “T101”, “T102”, and “T103” are recommended documents.

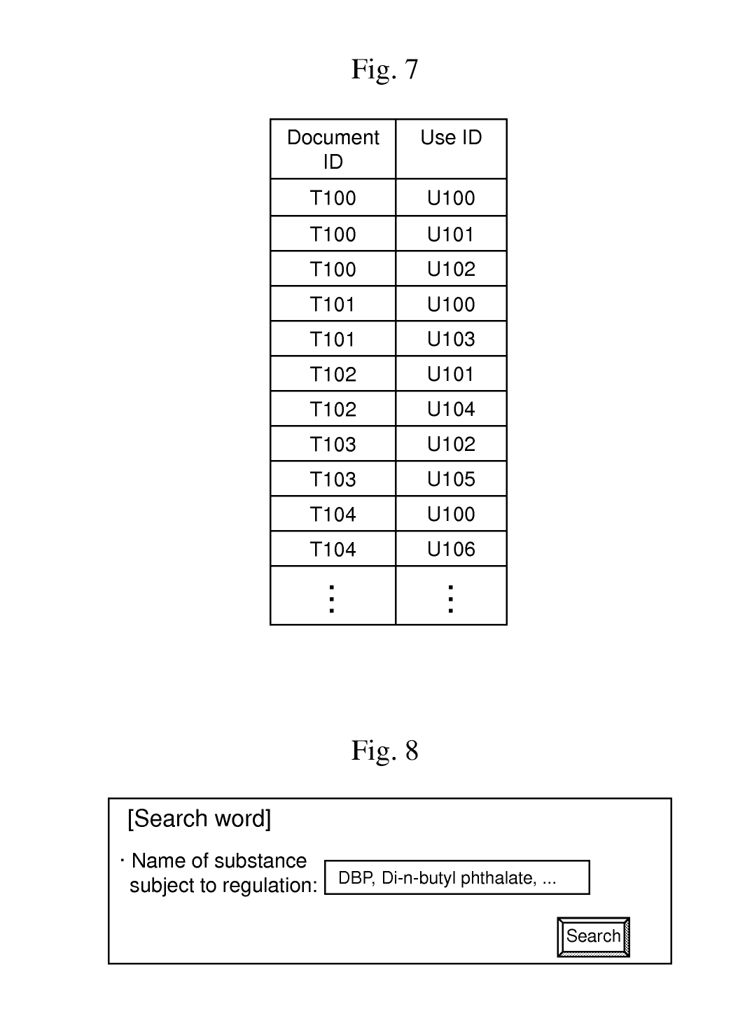

The by-document use information 224 includes information indicating which use information is described in each of the documents acquired from the document acquisition unit 321 which will be described later. FIG. 7 illustrates an example of the information constituting the by-document use information 224. The by-document use information 224 illustrated in FIG. 7 includes information regarding document ID and use ID. In the case of FIG. 7, the documents managed with the document ID “T100” indicate that the documents contain the use information with the use IDs “U100”, “U101”, and “U102”. With reference to the use information 222 illustrated in FIG. 5, it will be seen that in the documents managed with the document ID “T100”, the three words of “adhesive”, “plasticizer”, and “lubricant” are described.

The operating unit 300 acquires data necessary for computation from the input/output unit 100 or the input information 210 in the storage unit 200, and outputs a processing result to the output information 220 of the storage unit 200. The operating unit 300 includes an operating processing unit 320 that actually executes a computing process, and a memory unit 310 providing a work area for the computing process by the operating processing unit 320.

The memory unit 310 is used for temporarily retaining the data acquired from the input/output unit 100 or the input information 210 in the storage unit 200, or the result of processing by the operating processing unit 320.

The operating processing unit 320 includes the document acquisition unit 321, a use description range extraction unit 322, a use information extraction unit 323, the recommended document determination unit 324, and a display control unit 325. The document acquisition unit 321 acquires, based on a search word input by a user via the input/output unit 100, a list of documents acquired from the Web 400. The use description range extraction unit 322 extracts a text from the documents acquired by the document acquisition unit 321, and, thereafter, based on the search word, identifies a range in which the use information of the substance subject to regulation is described. The identified range here provides a use description range. The use information extraction unit 323 compares the range extracted by the use description range extraction unit 322 with the use keywords stored in the use word dictionary information 211, and extracts a corresponding keyword as the use information of the substance subject to regulation. The recommended document determination unit 324 selects from all of the documents acquired by the document acquisition unit 321 a combination of documents as investigation objects, and determines whether the use information described in the selected documents exhausts all of the use information extracted by the use information extraction unit 323. Here, the recommended document determination unit 324 determines a combination of the documents that exhausts all of the extracted use information as the recommended documents. The display control unit 325 displays the document information acquired by the document acquisition unit 321, the use information extracted by the use information extraction unit 323, and the information of the recommended documents identified by the recommended document determination unit 324 on the input/output unit 100.

### Content of Process Operation

With reference to the flowchart of FIG. 1, the process operation performed by each of the units of the investigation object document recommendation system 10 will be described. The process operation illustrated in FIG. 1 is started when the user inputs a search word via the input/output unit 100.

FIG. 8 illustrates an example of an input screen. The input screen illustrated in FIG. 8 includes an input field for directly inputting a substance name of a substance subject to regulation as a search word. In the input field, one or a plurality of search words may be input. For inputting a plurality of search words, a comma is used as illustrated in FIG. 8, for example. In the input screen illustrated in FIG. 8, when the user clicks the search button, the investigation object document recommendation system 10 starts a process.

According to the present embodiment, as illustrated in FIG. 8, the process operation of the investigation object document recommendation system 10 will be described in a case where “DBP” and “di-n-butyl phthalate” are input as the search words regarding the substances subject to regulation.

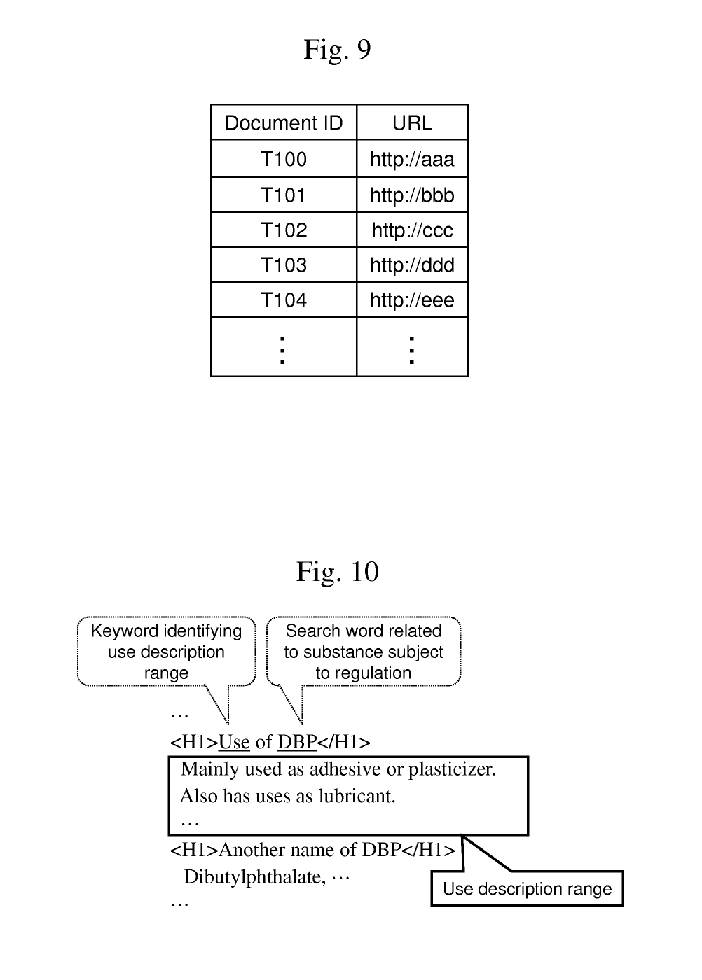

Referring back to FIG. 1, the document acquisition unit 321, upon reception of the information of the search words input through the input/output unit 100 such as a terminal, searches the Web 400 based on the received search words, and stores document information acquired from the Web 400 in the memory unit 310 (S100). An upper limit of the number of acquired documents may be designated by a program in advance, or it may be input via the input/output unit 100. According to the present embodiment, the URLs regarding the five documents with the document IDs “T100” to “T104” shown in FIG. 9, and the information of the documents described at the URLs are acquired.

Referring back to FIG. 1, when the document information is stored in the memory unit 310, the use description range extraction unit 322 accesses the search words and document information stored in the memory unit 310, and identifies and extracts a range in which the use information is described (S110). Here, an example of a method of extracting the use description range based on the information described in the document information will be described with reference to FIGS. 10 to 14.

FIG. 10 illustrates an example where the document information is described while being divided into chapters in HyperText Markup Language (HTML) format. In FIG. 10, “<H1> . . . </H1>” indicates an HTML tag denoting the sentence heading. In this case, the use description range extraction unit 322 extracts a space between a heading in which the search word and a keyword (such as “use” or “utilize”) identifying a use description range simultaneously appear and the heading appearing next as the use description range. In the example of FIG. 10, between <H1> . . . </H1> providing the initial heading, the search word “DBP” and the identifying keyword “use” appear simultaneously. Thus, the use description range extraction unit 322 extracts the space between this heading and the heading “<H1> another name of DBP</H1>” appearing next as the use description range.

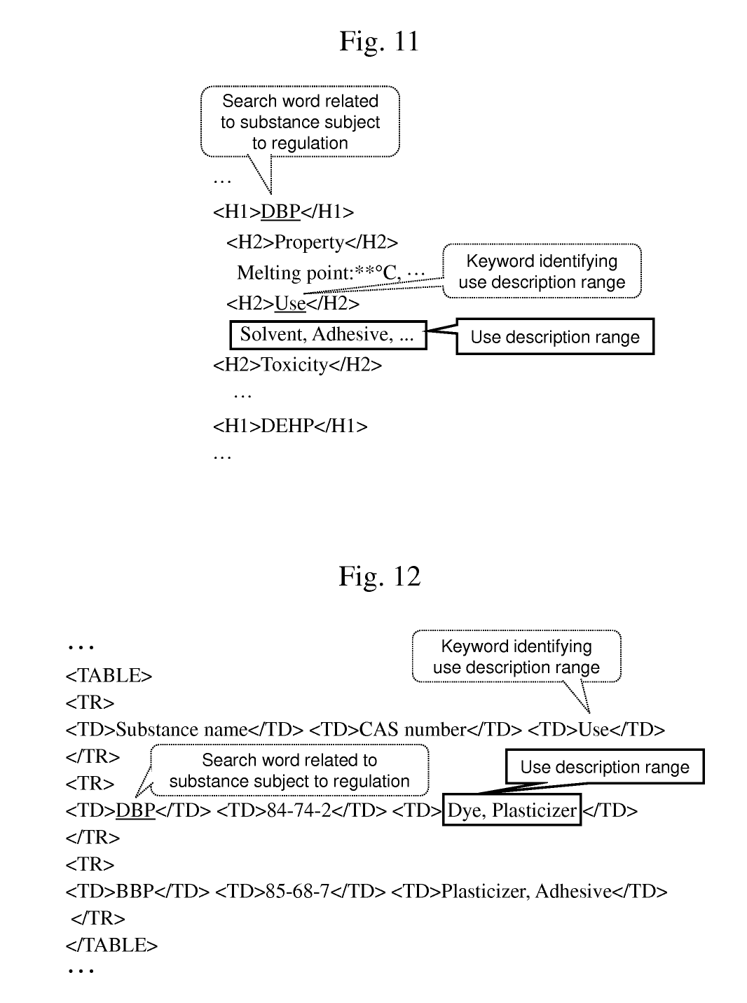

FIG. 11 illustrates an example in which the document information is described while being divided into chapters and sections in HTML format. In FIG. 11, “<H1> . . . </H1>” and “<H2> . . . </H2>” indicate HTML tags each denoting a heading. Generally, document information is divided into chapters, sections, and the like in the order of smaller to larger numbers in the tags. In the case of this description format, if the search word (or a keyword identifying a use description range) appears in the range of the heading with a smaller number (such as <H1> . . . </H1>), and if a keyword (or a search word) identifying the use description range appears in the range of the other heading (such as <H2> . . . </H2>), the use description range extraction unit 322 extracts the space before the heading with the larger number appears next as the use description range. In the case of the example of FIG. 11, in the space of <H1> . . . </H1> providing the initial heading, the search word “DBP” appears, while in the space of <H2> . . . </H2> providing the second heading, the identifying keyword “use” appears. Thus, the use description range extraction unit 322 extracts the space from this heading to prior to the next appearing heading “<H2> toxicity</H2>” as the use description range. When a plurality of headings, such as chapters/sections/paragraphs/ . . . , are used for description, the use description range may be extracted by the same method as described above.

FIG. 12 illustrates an example in which the document information is described as a table in HTML format. In FIG. 12, “<TABLE> . . . </TABLE>” indicates the HTML tags for describing a table. “<TR> . . . </TR>” are tags indicating one line of the table, and “<TD> . . . </TD>” are tags indicating one cell in the table. In the case of this description format, when a search word and a keyword identifying a use description range appear in the table simultaneously, the use description range extraction unit 322 extracts, of the cells at which the rows and columns of the cell in which the search word appears and the cell in which the keyword identifying the use description range appears intersect, extracts the inside of the range of the cell with a larger row value as the use description range. In the example of FIG. 12, there appears in the third <TD> . . . </TD> in the first <TR> . . . </TR> (first row, third column) the identifying keyword “use”, while in the first <TD> . . . </TD> in the second <TR> . . . </TR> (second row, first column), there appears the search word “DBP”. Thus, the use description range extraction unit 322, of the cells where these rows and columns intersect, selects the space of <TD> . . . </TD> in the second row and the third column where the row value is greater as the use description range.

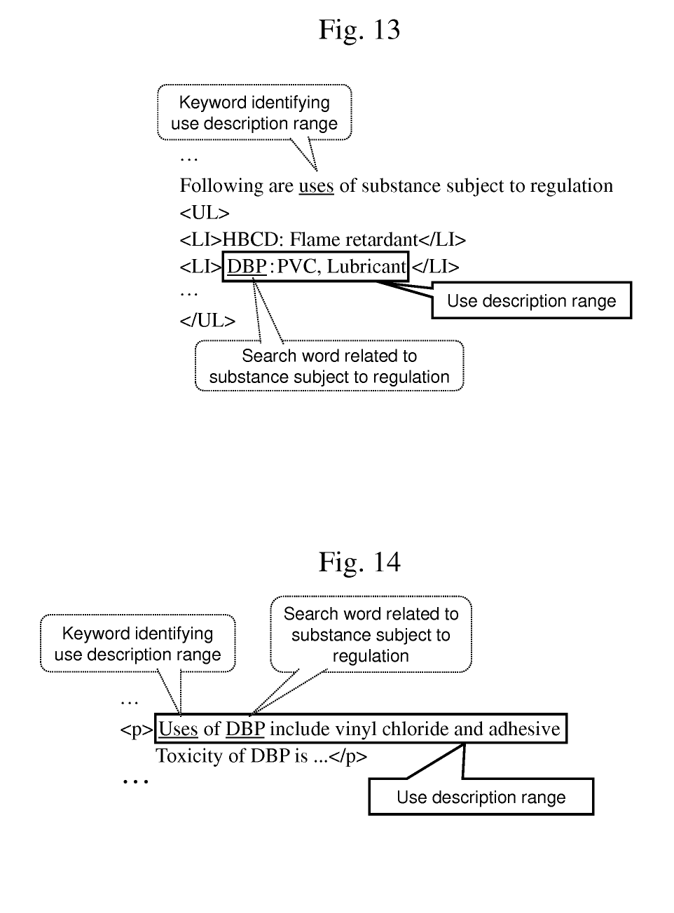

FIG. 13 illustrates an example in which the document information is described as a list in HTML format. In FIG. 13, <UL> . . . </UL> indicates the HTML tags for describing a list. “<LI> . . . </LI>” are the tags indicating one row of the list. In the case of this description format, the use description range extraction unit 322, when the search word (or a keyword identifying the use description range) appears in a sentence before <UL> . . . </UL>, and when the keyword (or search word) identifying the use description range appears in the <UL> . . . </UL>, selects the space of <LI> . . . </LI> in which the latter keyword appears as the use description range. In the case of the example of FIG. 13, in the sentence before <UL>, there appears the identifying keyword “use”, while in the second <LI> . . . </LI> in the <UL> . . . </UL>, the search word “DBP” appears. Thus, the use description range extraction unit 322 selects the space of the second <LI> . . . </LI> as the use description range.

FIG. 14 illustrates an example in which the document information is described as a sentence in HTML format. In FIG. 14, <p> . . . </p> indicate HTML tags for denoting a paragraph. In the case of this description format, the use description range extraction unit 322, when the search word and the keyword identifying the use description range appear in the same sentence simultaneously, selects the space from the tag <p> denoting the start of a paragraph or the punctuation mark “.” of the preceding sentence, to the tag </p> denoting the end of the paragraph or the punctuation mark “.” of the sentence in which the keyword and the search word appear simultaneously, as the use description range. In the example of FIG. 14, in the space from the tag <p> denoting the start of a paragraph to the first punctuation mark “.”, the search word “DBP” and the identifying keyword “use” appear simultaneously. Thus, the use description range extraction unit 322 selects this range as the use description range.

The following description will be made on the assumption that, according to the present embodiment, the use description range extraction unit 322 has stored the use description range extracted from the document information in the memory unit 310 in accordance with the extraction method illustrated in FIGS. 10 to 14. It should be noted, however, that the extraction technology applied in the use description range extraction unit 322 is not limited to the formats described above.

Referring back to FIG. 1, when the use description range is extracted, the use information extraction unit 323 compares the use word dictionary information 211 with the text information in the use description range extracted in S110, and extracts the corresponding use word as the use information of the substance subject to regulation (S120). Further, the use information extraction unit 323 stores the extracted use information in the memory unit 310 of the operating unit 300, and thereafter writes the information in the storage unit 200 as the output information 220 (use information 222).

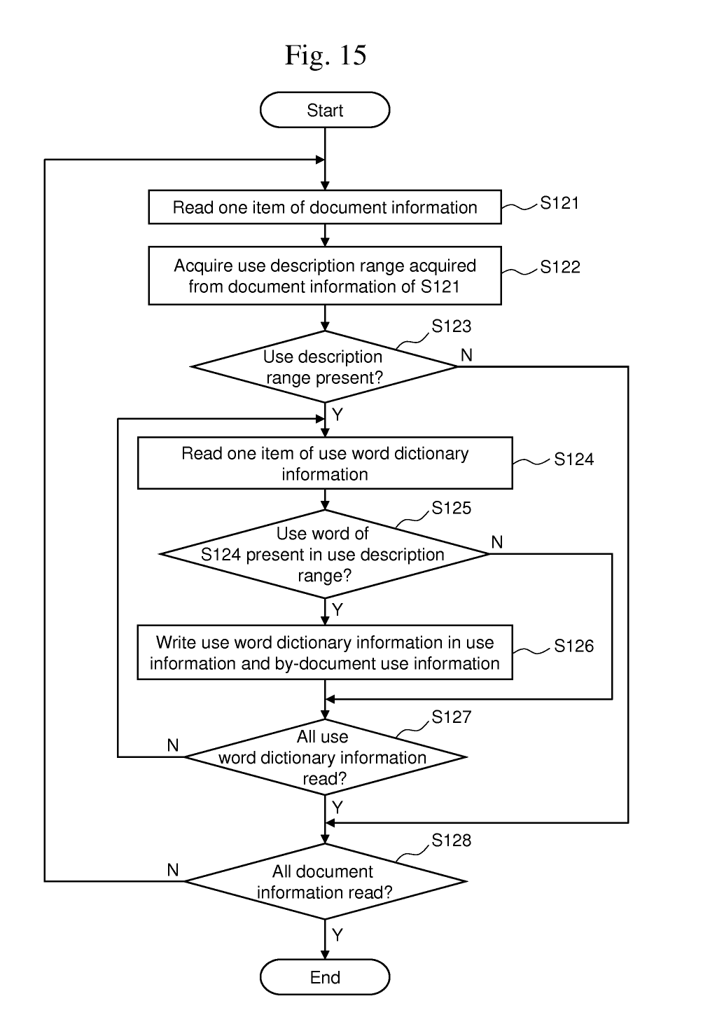

In the following, an operation performed by the use information extraction unit 323 will be described on the assumption that the use word dictionary information 211 illustrated in FIG. 3 is stored in the memory unit 310. FIG. 15 illustrates an example of the operation performed by the use information extraction unit 323.

First, the use information extraction unit 323 reads one item of the document information acquired in S100 (S121), and acquires the use description range extracted from the document information (S122). The use information extraction unit 323 then determines whether the use description range is present in the document information (S123). If the use description range is present, the use information extraction unit 323 proceeds to S124. If the use description range is not present, the use information extraction unit 323 proceeds to S128. Here, it is assumed that the use description range illustrated in FIG. 10 has been acquired from the document with the document ID “T100” illustrated in FIG. 9.

The use information extraction unit 323 then reads one record of the use word dictionary information 211 (S124), and determines whether the use word indicated by the record is present in the use description range (S125). If the use word is not present, the use information extraction unit 323 proceeds to S127. If the use word is present, the use information extraction unit 323 writes the use word dictionary information in the memory unit 310 and the use information 222, while writing the document information and the use word dictionary information in the memory unit 310 and the by-document use information 224 (S126). Here, a case is considered in which the use information extraction unit 323 has read the record with the use ID “U100” and the use word “adhesive” shown in FIG. 3. In the use description range illustrated in FIG. 10, the use word “adhesive” is present. Thus, the use information extraction unit 323 writes the use word dictionary information in the first record of the use information 222 shown in FIG. 5, while writing the document ID “T100” and the use ID “U100” in the first record of the by-document use information 224 shown in FIG. 7.

Thereafter, the use information extraction unit 323 determines whether all of the use word dictionary information 211 has been read (S127). If not all of the records in the use word dictionary information 211 have been read, the use information extraction unit 323 returns to S124. If all of the records in the use word dictionary information 211 have been read, the use information extraction unit 323 proceeds to S128. When the process of S124 to S127 is repeated with respect to all of the use word dictionary information 211 shown in FIG. 3 for the document with the document ID “T100”, the first to third records of the use information 222 shown in FIG. 5 are generated. Also, the first to third records of the by-document use information 224 shown in FIG. 7 are generated.

For the current document information, when the process of S124 to S127 ends with respect to all of the use word dictionary information 211 shown in FIG. 3, the use information extraction unit 323 determines whether all of the document information acquired in S100 has been read (S128). If not all of the document information has been read, the use information extraction unit 323 returns to S121 and reads one item of the next document information. If all of the document information has been read, the use information extraction unit 323 ends the process of FIG. 15.

When the process of S121 to S128 is executed with respect to the use word dictionary information 211 shown in FIG. 3 and the use description range illustrated in FIGS. 10 to 14, all of the information of the use information 222 shown in FIG. 5 and the by-document use information 224 shown in FIG. 7 are generated.

Referring back to FIG. 1, when the use information is extracted, the recommended document determination unit 324 sets the number of the investigation object documents (N) to 1 (S130), and selects N combinations from the document information extracted in S100 (S140). Here, it is assumed that the record with the document ID “T100” has been selected from the document information group shown in FIG. 9.

First, the recommended document determination unit 324 determines whether the use information described in the document information (document ID “T100”) exhausts all of the use information extracted in S120 (S150). If not all of the use information is exhausted, the recommended document determination unit 324 proceeds to S160. If all of the use information is exhausted, the recommended document determination unit 324 proceeds to S180.

In the by-document use information 224 shown in FIG. 7, the use information described in the document ID “T100” includes the use words indicated by the use IDs “U100”, “U101”, and “U102”; namely the three items of “adhesive”, “plasticizer”, and “lubricant”. However, these three use words do not exhaust all of the use information 222 extracted in S120 and shown in FIG. 5. Thus, the recommended document determination unit 324 proceeds to S160.

In S160, the recommended document determination unit 324 determines whether the process of S150 has been executed with respect to all combinations of the document information in the range of the number of the investigation object documents (N) at the current point in time. If not all of the combinations of the document information has been processed, the recommended document determination unit 324 returns S140. Here, because the records with the document ID “T100” have been selected, the determination process of S150 is executed with respect to the records with the document ID “T101” among the document information group shown in FIG. 9. If the exhaustion of the use information is not confirmed, it is thereafter confirmed whether all of the use information is exhausted with respect to the document information with the document IDs “T102”, “T103”, “T104”, and so on.

If there is no combination of the document information that exhausts the use information with respect to all of the combinations of the current number of the investigation object documents N, the recommended document determination unit 324 proceeds to S170 and returns to S140 after adding 1 to N.

If the number of the investigation object documents (N) is 1, there is no document information that independently exhausts all of the use information 222 shown in FIG. 5 no matter which of the document information shown in FIG. 9 is selected. Thus, the recommended document determination unit 324 modifies the number of the investigation object documents (N) to 2 and then returns to S140. In the present embodiment, the process of S140 to S170 is repeatedly executed as long as N=2. Here, when N=3 and the combination of the document IDs “T101”, “T102”, and “T103” shown in FIG. 9 is generated, it is confirmed that all of the use information 222 shown in FIG. 5 is exhausted. For this confirmation, the by-document use information 224 illustrated in FIG. 7 is used. The use word “vinyl chloride” with the use ID “U106” shown in FIG. 5 does not cover the use information 222. However, because the use word “PVC” with the use ID “U105” having the same synonym ID “S100” covers the use information 222, it is determined that the use ID “U106” is also covered.

Finally, the recommended document determination unit 324 writes in the document information 223 the documents providing the combination of the document information that was selected in S140 and from which the affirmative result was obtained in S150 as the recommended documents (S180). The display control unit 325 outputs the search word information 221, the use information 222, the document information 223, and the by-document use information 224 to the input/output unit 100 (S180).

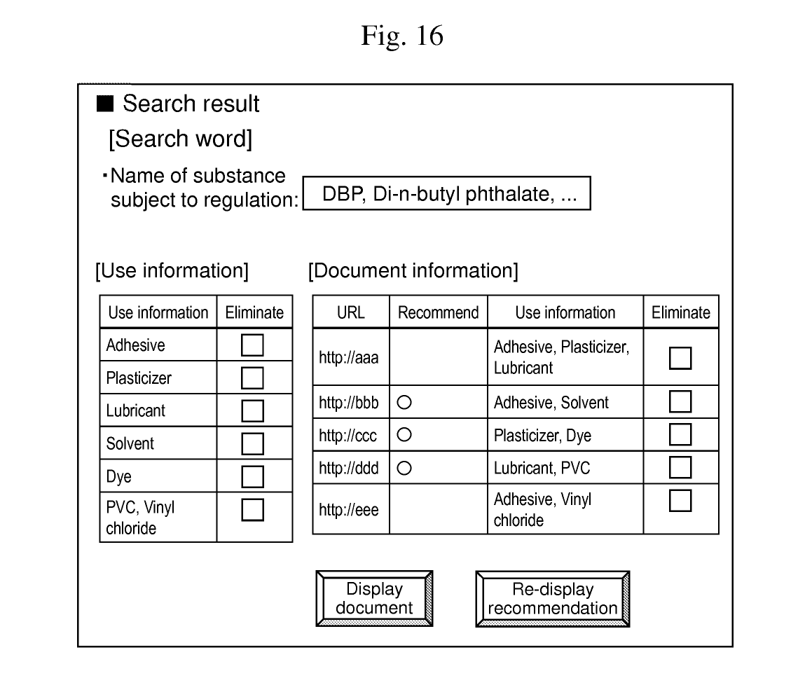

At this time, the recommended document determination unit 324 writes, in the document information 223 shown in FIG. 6, “1 (recommend)” in the recommendation flag for the document IDs “T101”, “T102”, and “T103”, while writing “0” in the recommendation flags corresponding to the other documents. The display control unit 325 displays an output screen shown in FIG. 16, for example. In the search word field of FIG. 16, the information of the search word information 221 shown in FIG. 4 is displayed. In the use information field of FIG. 16, the information of the use information 222 shown in FIG. 5 is displayed. In the document information field of FIG. 16, the URLs of all of the document information 223 acquired in S100 are displayed. In the case of FIG. 16, a recommend field is provided in the cell adjacent to URL, and a circle is displayed for the document with the recommendation flag “1”. Further, in the case of FIG. 16, a list of use information described in the document corresponding to each URL is displayed on the basis of the information of the by-document use information 224 shown in FIG. 7. In the output screen of FIG. 16, when a URL in the document information field is selected and the “Display document” button is clicked, the user can confirm the use information from the relevant document present on the Web 400. In each of the rows in the use information field and the document information field in FIG. 16, an elimination check box is provided. When a “Re-display recommendation” button is clicked with the box checked, the investigation object document recommendation system 10 executes the process of S130 to S180 again while eliminating the use information or document information checked for elimination, and displays the execution result as a search result screen. By thus providing the elimination check box, even when use information and document information with low reliability are mixed, the recommended document information with feedback of a user determination result can be presented.

### Conclusion

By using the investigation object document recommendation system 10 according to the present embodiment, when information regarding a specific field, such as the use information of a substance subject to regulation that is contained in a component, is collected from the Web, target keywords regarding use information and the like can be automatically acquired from collected documents, and a combination of the minimum number of investigation object documents that exhaust all of the keywords can be provided to the user. Thus, according to the present embodiment, the investigation object document recommendation system 10 can decrease the man-hour for investigating the use information for prioritizing components having a high probability of containing the substance subject to regulation, whereby the man-hour or cost for investigation or examination of the components containing the substance subject to regulation can be generally decreased.

### Embodiment 2

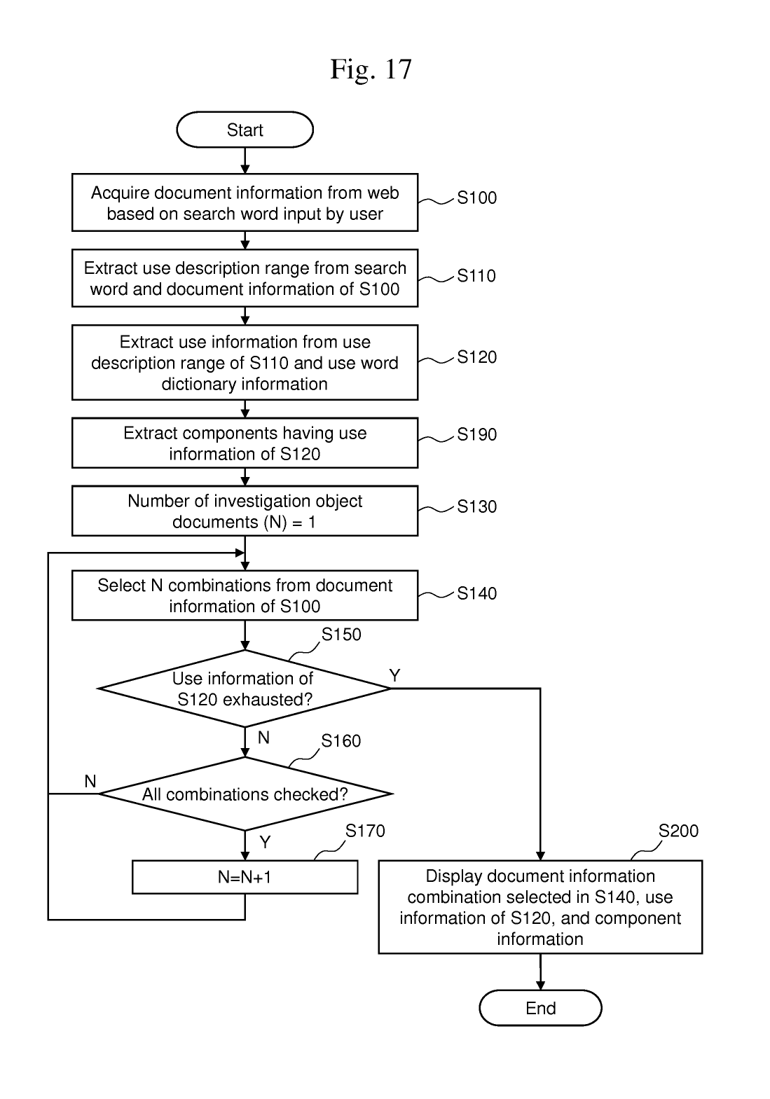

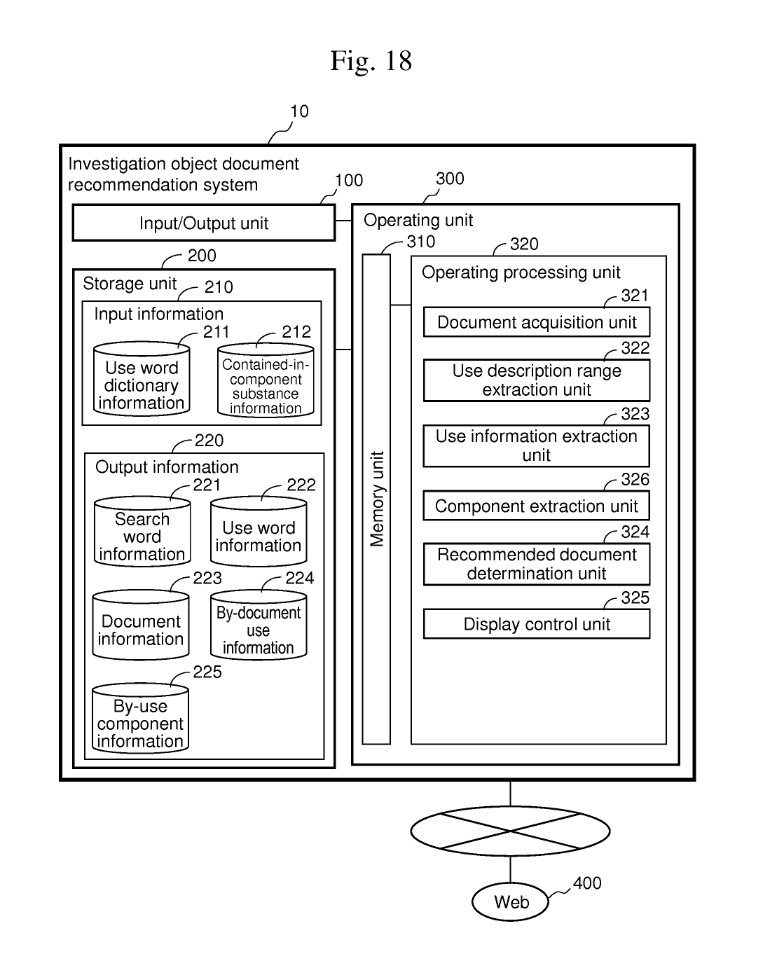

In the following, the investigation object document recommendation system according to the present embodiment will be described with reference to FIG. 17 and FIG. 18. In the present embodiment, the investigation object document recommendation system capable of presenting investigation object article information together with the recommended documents will be described. FIG. 17 illustrates an example of the process flow according to the present embodiment. FIG. 18 is a functional block diagram of the system configuration of the present embodiment. In FIG. 17, portions corresponding to FIG. 1 are designated with similar signs. In FIG. 18, portions corresponding to FIG. 2 are designated with similar signs.

### System Configuration

One of the differences between the investigation object document recommendation system 10 illustrated in FIG. 18 and the investigation object document recommendation system 10 illustrated in FIG. 2 is that the storage unit 200 is additionally provided with contained-in-component substance information 212 and by-use component information 225.

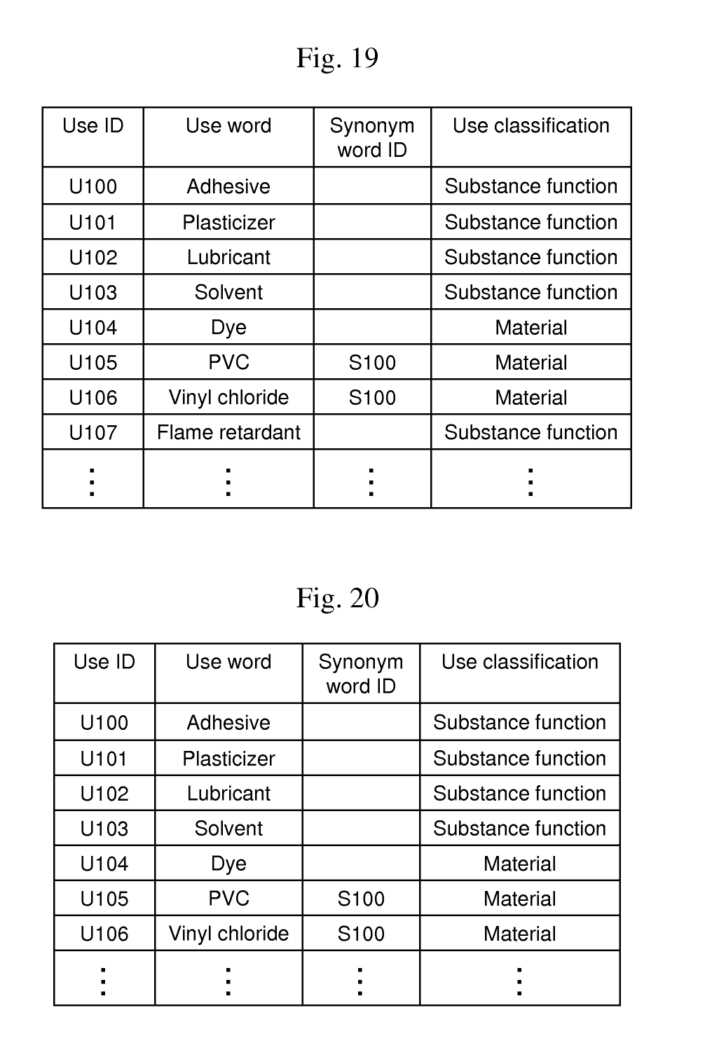

Another difference is that in the case of the present embodiment, the use word dictionary information 211 has a data structure shown in FIG. 19, and the use information 222 has a data structure shown in FIG. 20. The use word dictionary information 211 shown in FIG. 19 and the use information 222 shown in FIG. 20 differ from the respectively corresponding FIG. 3 and FIG. 5 in that there is added a column for “Use classification” indicating a classification (such as substance function or material) of use-regarding keywords.

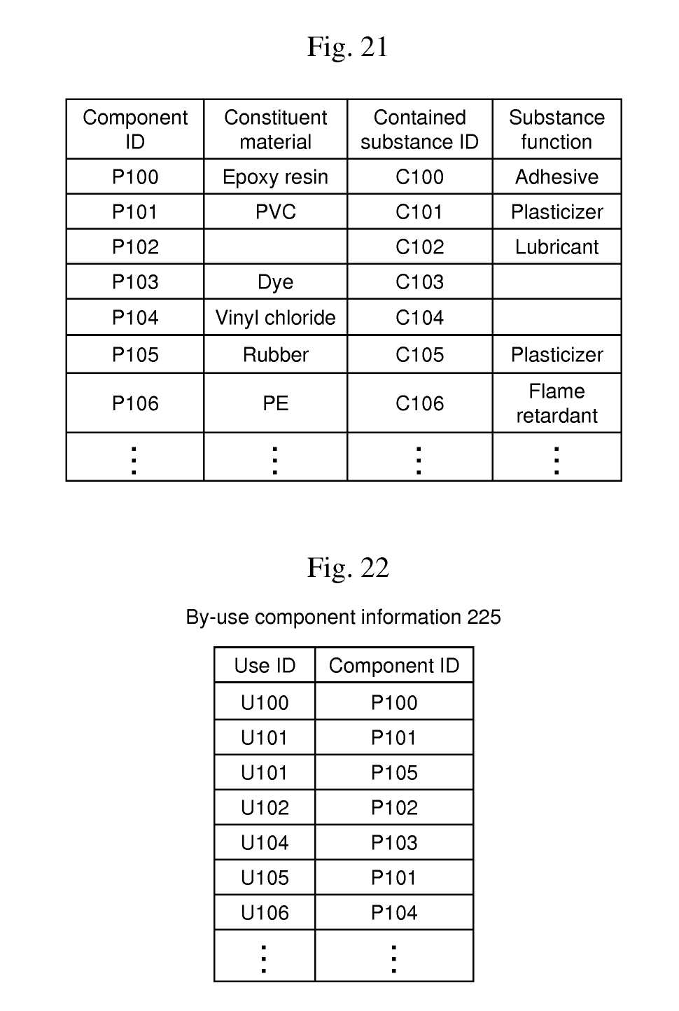

The contained-in-component substance information 212 includes information for managing the information of chemical substances included in components procured from a supplier or manufactured independently. FIG. 21 illustrates an example of the information comprising the contained-in-component substance information 212. The contained-in-component substance information 212 shown in FIG. 21 includes the information of component ID, constituent material, contained substance ID, and substance function. In the case of the example of FIG. 21, the data with the component ID “P100”, for example, indicates that “epoxy resin” is included in the material constituting the component, and that the material includes a substance with the contained substance ID “C100” having the function of “adhesive”.

The by-use component information 225 includes information for managing information of related components for each use. FIG. 22 illustrates an example of the information constituting the by-use component information 225. The by-use component information 225 shown in FIG. 22 includes information about use ID and component ID. In the case of the example of FIG. 22, the use ID “U100” (indicating “adhesive” based on the use information 222 shown in FIG. 19) is indicated to have a relationship with the component ID “P100”.

Further, the present embodiment differs in that the operating processing unit 320 of the operating unit 300 is provided with a component extraction unit 326. The process function of the component extraction unit 326 will be described later. Other functions of the investigation object document recommendation system 10 illustrated in FIG. 18 may be similar to those of the investigation object document recommendation system 10 illustrated in FIG. 2.

### Content of Process Operation

A process operation executed by each unit of the investigation object document recommendation system 10 illustrated in FIG. 18 will be described with reference to the flowchart of FIG. 17.

In the case of the present embodiment too, the user directly inputs a keyword regarding a substance name of a substance subject to regulation via the input screen shown in FIG. 8, for example, as a search word. In the present embodiment too, it is assumed that the same search words as in Embodiment 1, i.e., “DBP” and “di-n-butyl phthalate”, are input as the search words regarding the substances subject to regulation.

Upon reception of the information of the search words input via the input/output unit 100, such as a terminal, the document acquisition unit 321 searches the Web 400 based on the received search words, and stores the document information acquired from the Web 400 in the memory unit 310 (S100). In the present embodiment too, as in Embodiment 1, the URLs regarding the five documents with the document IDs “T100” to “T104” shown in FIG. 9, and the information of the documents (FIG. 10 to FIG. 14) described at these URLs are acquired.

Referring back to the description of FIG. 17, when the document information is stored in the memory unit 310, the use description range extraction unit 322 accesses the search words and document information stored in the memory unit 310, and identifies and extracts the range in which the use information is described (S110). In the case of the present embodiment too, the use description range is extracted using the same method as in Embodiment 1. Thus, redundant description will be omitted. Further, in the case of the present embodiment too, it is assumed that, as in Embodiment 1, the use description range described in FIG. 10 to FIG. 14 is extracted from the document information and stored in the memory unit 310.

The use information extraction unit 323 then compares the use word dictionary information 211 with the text information in the use description range extracted in S110, and extracts the corresponding use word as the use information of the substance subject to regulation (S120). The use information extraction unit 323 further stores the extracted use information in the memory unit 310 in the operating unit 300, and thereafter writes the information in the output information 220 (use information 222). In the present embodiment, it is assumed that the use word dictionary information 211 shown in FIG. 19 is read. The operation of the use information extraction unit 323 according to the present embodiment is the same as the operation of the use information extraction unit 323 according to Embodiment 1. Thus, redundant description will be omitted, and it is assumed that the use information 222 shown in FIG. 20 and the information of the by-document use information 224 are generated.

Here, the component extraction unit 326, based on the use information 222 extracted in S120, extracts a component having the use information 222 from the contained-in-component substance information 212, and writes the component in the by-use component information 225 (S190). In the present embodiment, it is assumed that, based on the use information 222 shown in FIG. 20, a component is extracted from the contained-in-component substance information 212 shown in FIG. 21.

First, the component extraction unit 326 extracts from the use information 222 shown in FIG. 20 the first record (use ID “U100”, use word “adhesive”, use classification “substance function”), and searches the contained-in-component substance information 212 shown in FIG. 21. In this case, the use classification is “substance function”. Thus, the component extraction unit 326 searches the contained-in-component substance information 212 shown in FIG. 21 for a component with the substance function “adhesive”, and acquires the relevant component ID “P100”. The component extraction unit 326 writes the acquired component ID “P100” in the by-use component information 225 shown in FIG. 22 in association with the use ID “U100”.

When the fifth record (use ID “U104”, use word “dye”, use classification “material”) is extracted from the use information 222 shown in FIG. 20, the use classification is “material”. Thus, the component extraction unit 326 searches the contained-in-component substance information 212 shown in FIG. 21 for the component with the constituent material “dye”, and acquires the relevant component ID “P103”. The component extraction unit 326 writes the acquired component ID “P103” in the by-use component information 225 shown in FIG. 22 in association with the use ID “U104”.

Thus, by providing each use ID with use classification, the keyword that is searched for can be classified at the time of component extraction. By executing the above processes with respect to all of the use information 222 shown in FIG. 20, the by-use component information 225 shown in FIG. 22 is generated.

Referring back to the description of FIG. 17, when the component information is extracted in S190, the recommended document determination unit 324 sets the number of the investigation object documents (N) to 1 (S130), and selects N combinations from the document information extracted in S100 (S140).

Then, the recommended document determination unit 324 determines whether the use information described in the document information exhausts all of the use information extracted in S120 (S150). If not all of the information is exhausted, the process proceeds to S160; if exhausted, the process proceeds to S200.

Thereafter, the recommended document determination unit 324 determines whether the process of S150 has been executed with respect to all of the document information combinations in the range of the number of the investigation object documents (N) at the current point in time (S160). If not, the process returns to S140; if executed, the process advances to S170, and then returns to S140 after adding 1 to N.

Finally, the recommended document determination unit 324 writes the documents selected in S140 in the document information 223 as the recommended documents (S200). At this time, the display control unit 325 outputs the search word information 221, the use information 222, the document information 223, the by-document use information 224, and the by-use component information 225 to the input/output unit 100 (S200). Here, the process of S130 to S170 is similar to Embodiment 1 and a description of the process will be omitted. It is herein assumed that a recommendation flag has been written for each of the documents providing the combination presented as the recommended documents, as in the document information 223 shown in FIG. 6.

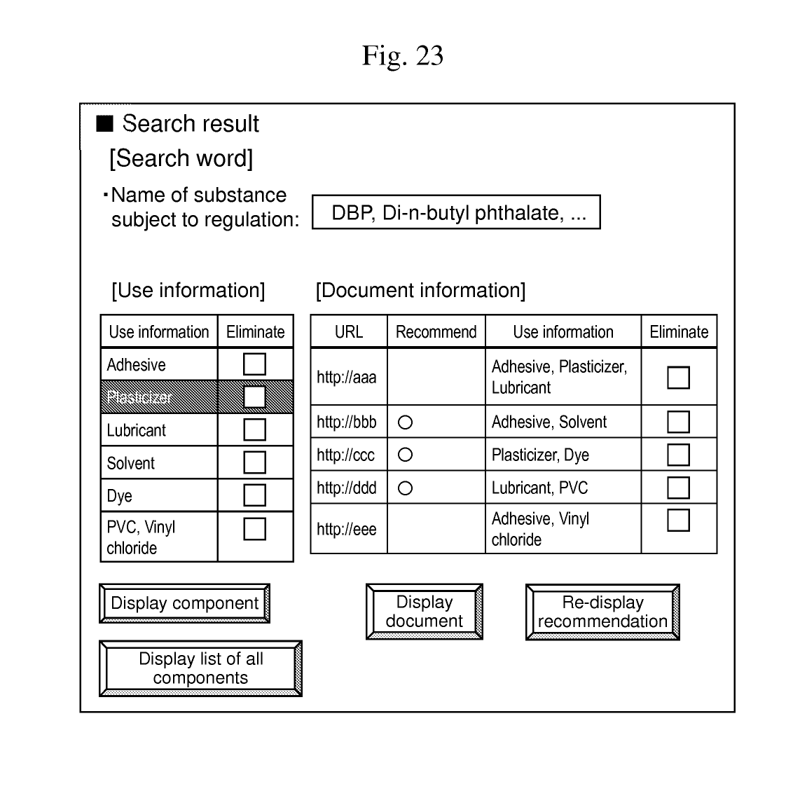

In the case of the present embodiment, the display control unit 325 displays an output screen shown in FIG. 23, for example. The output screen shown in FIG. 23 is provided with a “Display components” button and a “Display all component lists” button which are not present in the output screen shown in FIG. 16. The other display fields and the buttons are the same as those shown in FIG. 16.

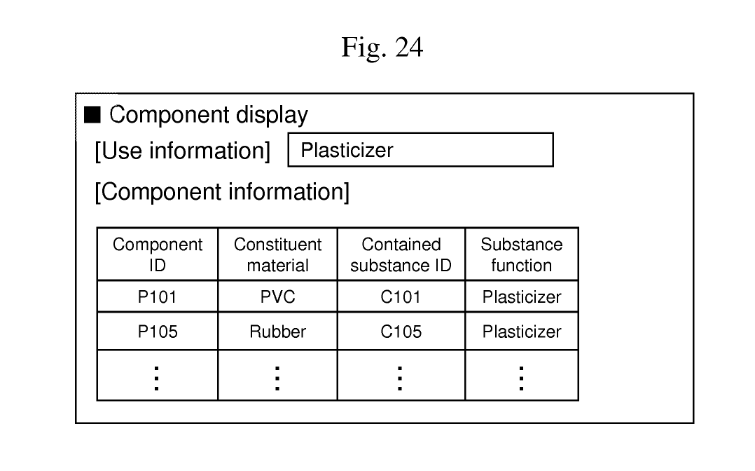

In the output screen shown in FIG. 23, when the user selects one row from the use information field and clicks the “Display component” button, the display control unit 325 causes the input/output unit 100 to display a display shown in FIG. 24, for example. FIG. 24 shows a display example in a case where, in the output screen of FIG. 23, the “Display component” button has been clicked when the “plasticizer” (use ID “U101” from FIG. 20) is selected. In this case, the display control unit 325 acquires from the by-use component information 225 the component IDs “P101” and “P105”, acquires the component information having the component IDs from the contained-in-component substance information 212, and displays the screen shown in FIG. 24.

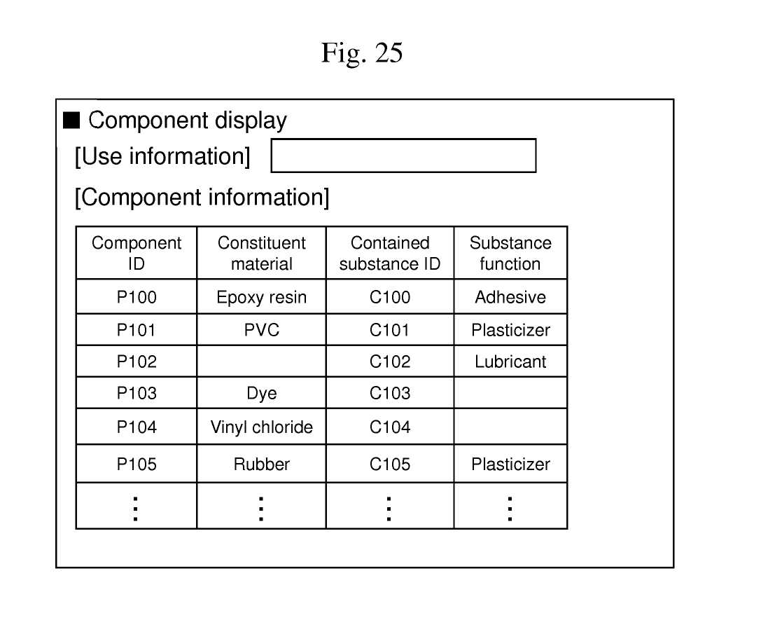

In the output screen shown in FIG. 23, when the “Display all component lists” button is clicked, the display control unit 325 causes the input/output unit 100 to display a screen shown in FIG. 25, for example. On the screen shown in FIG. 25, the component information having all of the component IDs present in the by-use component information 225 shown in FIG. 22 are displayed.

### Conclusion

By using the investigation object document recommendation system 10 according to the present embodiment, in addition to providing the effects indicated in Embodiment 1, it becomes possible to display a list of components related to the extracted use information, or components with a high probability of containing the substance subject to regulation. Thus, the component investigation and examination after the combination of the exhaustive documents with the minimum number of the investigation object documents is clarified can be efficiently performed.

### Embodiment 3

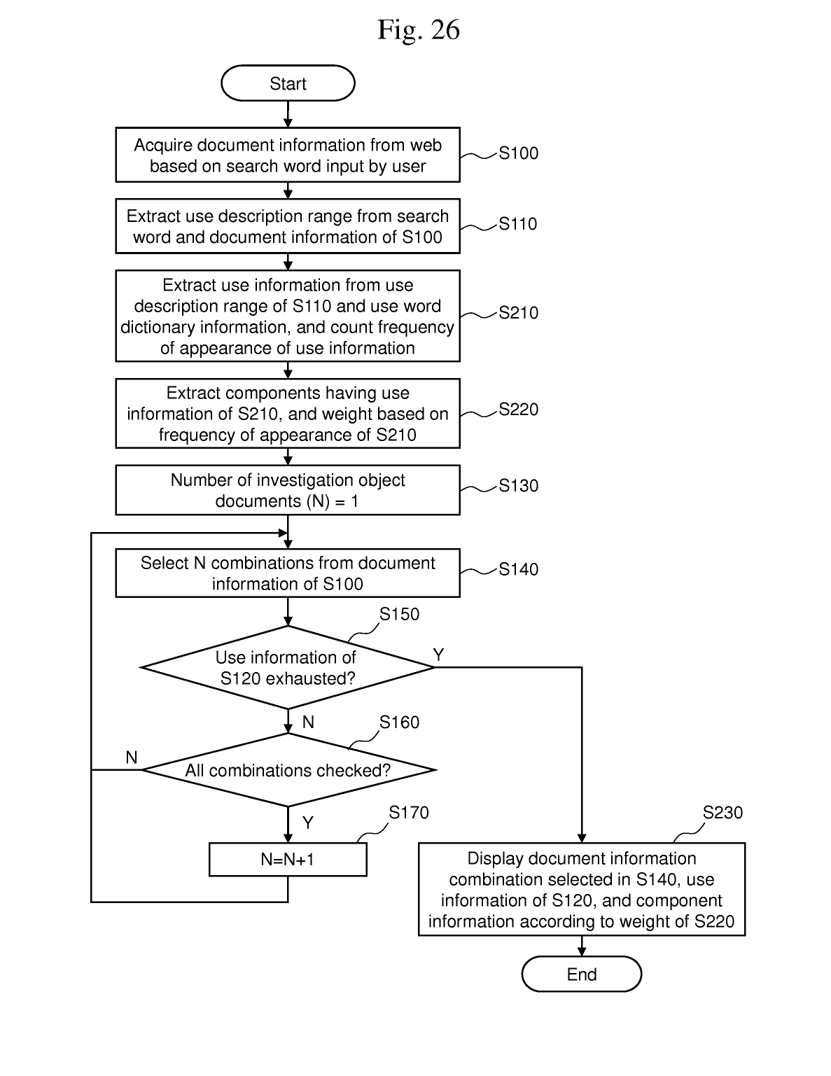

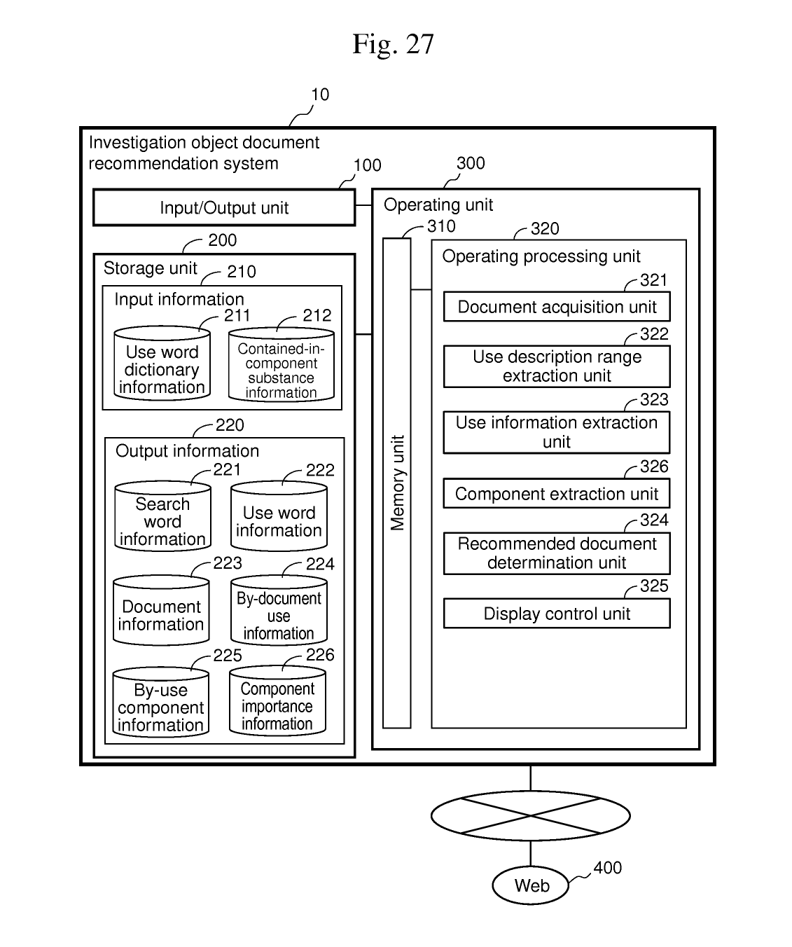

In the following, the investigation object document recommendation system according to the present embodiment will be described with reference to FIG. 26 and FIG. 27. In the present embodiment, a description will be given of the investigation object document recommendation system that, based on the frequency of appearance (importance) of use information that appears in all of the extracted documents, the investigation object components are prioritized and displayed together with the recommended documents. FIG. 26 illustrates an example of the process flow according to the present embodiment. FIG. 27 is a functional block diagram of the system configuration of the present embodiment. In FIG. 26, portions corresponding to those of FIG. 17 will be designated with similar signs. In FIG. 27, portions corresponding to those of FIG. 18 will be designated with similar signs.

### System Configuration

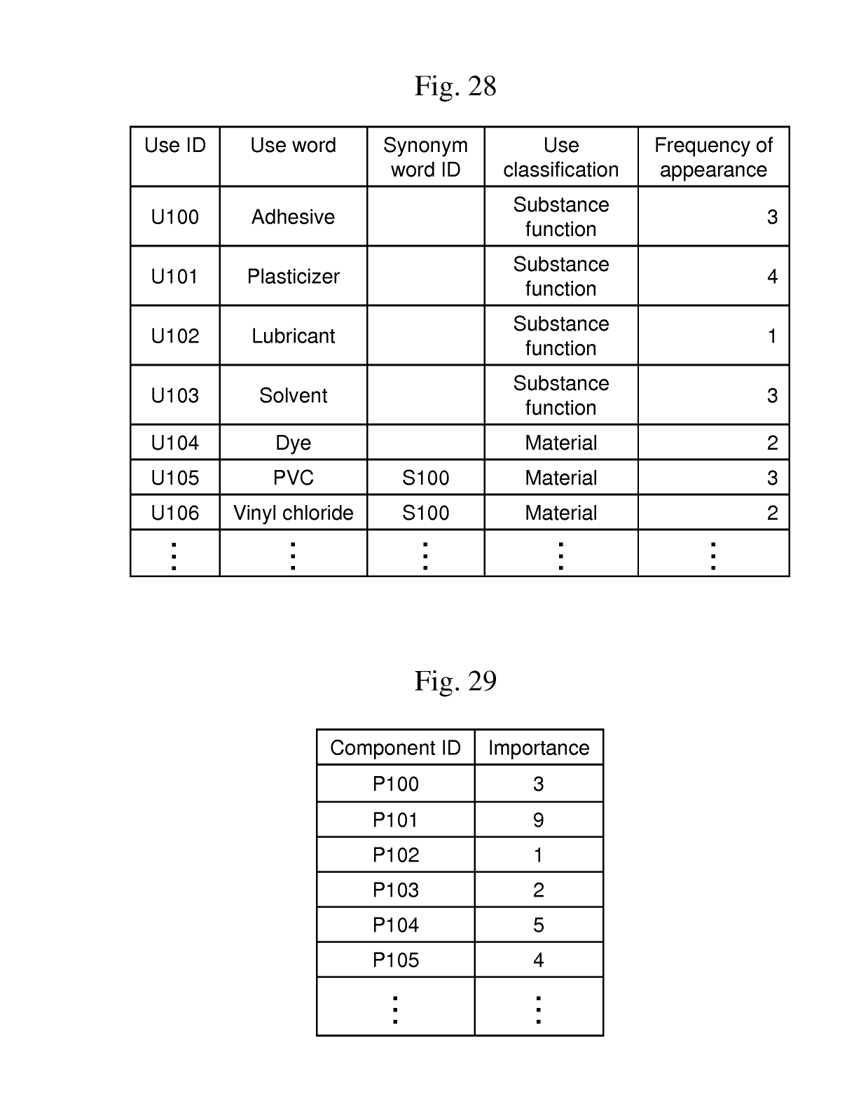

The investigation object document recommendation system 10 illustrated in FIG. 27 differs from the investigation object document recommendation system 10 illustrated in FIG. 18 in that the storage unit 200 is additionally provided with component importance information 226. Another difference is that in the case of the present embodiment, a data structure shown in FIG. 28 is adopted as the use information 222. The use information 222 shown in FIG. 28 differs from the information shown in FIG. 20 in that a column for the frequency of appearance indicating the number of documents appearing on a use word basis is added.

The component importance information 226 added in the present embodiment includes information for managing the importance of each component related to the use information. FIG. 29 illustrates an example of the information constituting the component importance information 226. The component importance information 226 shown in FIG. 29 includes information regarding component ID and importance. A method of computing the importance will be described later.

### Content of Process Operation

With reference to the flowchart shown in FIG. 26, a process operation executed by each of the units of the investigation object document recommendation system 10 shown in FIG. 27 will be described.

In the case of the present embodiment too, the user directly inputs a keyword regarding the substance name of the substance subject to regulation as a search word via the input screen shown in FIG. 8, for example. In the present embodiment too, it is assumed that the same search words as in Embodiment 1, namely, “DBP” and “di-n-butyl phthalate”, are input as the search words regarding the substance subject to regulation.

The document acquisition unit 321, upon reception of the information of the search words input via the input/output unit 100, such as a terminal, searches the Web 400 based on the received search words, and stores the document information acquired from the Web 400 in the memory unit 310 (S100). In the present embodiment, as in Embodiment 1, it is assumed that the URLs regarding the five documents with the document IDs “T100” to “T104” shown in FIG. 9, and the information of the documents described at the URLs (FIG. 10 to FIG. 14) are acquired.

Referring back to the description of FIG. 26, when the document information is stored in the memory unit 310, the use description range extraction unit 322 accesses the search words and document information stored in the memory unit 310, and identifies and extracts the range in which the use information is described (S110). In the case of the present embodiment too, the use description range is extracted by the same method as in Embodiment 1. Thus, redundant description will be omitted. Further, in the case of the present embodiment, as in Embodiment 1, it is assumed that the use description range shown in FIG. 10 to FIG. 14 is extracted from the document information and stored in the memory unit 310.

The use information extraction unit 323 then compares the use word dictionary information 211 with the text information in the use description range extracted in S110, and extracts the corresponding use word as the use information of the substance subject to regulation (S210). The use information extraction unit 323 further stores the extracted use information in the memory unit 310 of the operating unit 300, and thereafter writes the information in the output information 220 (use information 222)(S210).

It is assumed herein that the use word dictionary information 211 shown in FIG. 19 is read. For example, when the use information is extracted from the text information in the use description range shown in FIG. 10, the use information extraction unit 323 extracts “adhesive”, “plasticizer”, and “lubricant”, and counts one for the frequency of appearance of each item of the use information. The use information extraction unit 323 executes this count process with respect to all of the document information acquired in S100. As a result, the number of documents that appear according to use information is counted up. The use information extraction unit 323 writes the count value in the use information 222. It is herein assumed that the use information 222 shown in FIG. 28 and the by-document use information 224 shown in FIG. 7 are generated.

The component extraction unit 326, based on the use information 222 extracted in S210, extracts a component having the use information 222 from the contained-in-component substance information 212, writes the component in the by-use component information 225, and generates the by-component importance information 226 based on the frequency of appearance by use information that has been counted in S210 (S220). In the present embodiment, it is assumed that, based on the use information 222 shown in FIG. 28, a component is extracted from the contained-in-component substance information 212 shown in FIG. 21.

First, the component extraction unit 326 extracts the first record (use ID “U100”, use word “adhesive”, use classification “substance function”, frequency of appearance “3”) from the use information 222 shown in FIG. 28, and searches the contained-in-component substance information 212 shown in FIG. 21. In this case, the use classification is “substance function”. Thus, the component extraction unit 326 searches the contained-in-component substance information 212 shown in FIG. 21 for a component with the substance function “adhesive”, acquires the relevant component ID “P100”, and writes the component in the by-use component information 225 shown in FIG. 22 in association with the use ID “U100”. In this case, the frequency of appearance of the record is “3”. Accordingly, the component extraction unit 326 writes the importance “3” in the component ID “P100”.

When the sixth record (use ID “U105”, use word “PVC”, synonym ID “S100”, use classification “material”, frequency of appearance “3”) is extracted from the use information 222 shown in FIG. 28, the use classification is “material”. Thus, the component extraction unit 326 searches the contained-in-component substance information 212 shown in FIG. 21 for a component with the constituent material “PVC”, and acquires the relevant component ID “P101”. The component extraction unit 326 writes the acquired component ID “P101” in the by-use component information 225 shown in FIG. 22 in association with the use ID “U105”.

In this case too, the frequency of appearance of the record is “3”. However, in the use ID “U105”, the synonym ID “S100” is registered. Thus, the component extraction unit 326 extracts another record with the synonym ID “S100” (use ID “U106”, use word “vinyl chloride”, synonym ID “S100”, use classification “material”, frequency of appearance “2”) from the use information 222, and acquires the frequency of appearance “2” of the record. The component extraction unit 326 adds, to the frequency of appearance “2” of the use ID “U106”, the frequency of appearance “3” of the use ID “U105”, computing the value “5” as the importance. The component extraction unit 326 writes the computed importance “5” in the component importance information 226 in association with the component ID “P101”.

The above processes are executed with respect to all of the use information 222 shown in FIG. 28. When the calculation of the importance of each article ID is completed with respect to all of the use information 222, the by-use component information 225 shown in FIG. 22, and the component importance information 226 shown in FIG. 29 are generated.

Referring back to the description of FIG. 26, when the calculation of the importance for each article ID is completed in S220, the recommended document determination unit 324 sets the number of the investigation object documents (N) to 1 (S130), and selects N combinations from the document information extracted in S100 (S140).

Thereafter, the recommended document determination unit 324 determines whether the use information described in the document information exhausts all of the use information extracted in S120 (S150). If not, the process proceeds to S160. If all of the use information is exhausted, the process proceeds to S230.

The recommended document determination unit 324 then determines whether the process of S150 has been executed with respect to all combinations of the document information in the range of the number of the investigation object documents (N) at the current point in time (S160). If not, the process returns to S140. If the process has been executed, the process proceeds to S170 and returns to S140 after adding 1 to N.

Finally, the recommended document determination unit 324 writes the documents selected in S140 in the document information 223 as the recommended documents (S230). At this time, the display control unit 325 outputs the search word information 221, the use information 222, the document information 223, the by-document use information 224, the by-use component information 225, and the component importance information 226 to the input/output unit 100 (S230). The process of S130 to S170 is similar to Embodiment 1 and therefore a description of the process will be omitted. It is herein assumed that the recommendation flag is written for each of the documents providing the combination presented as the recommended documents, as in the document information 223 shown in FIG. 6.

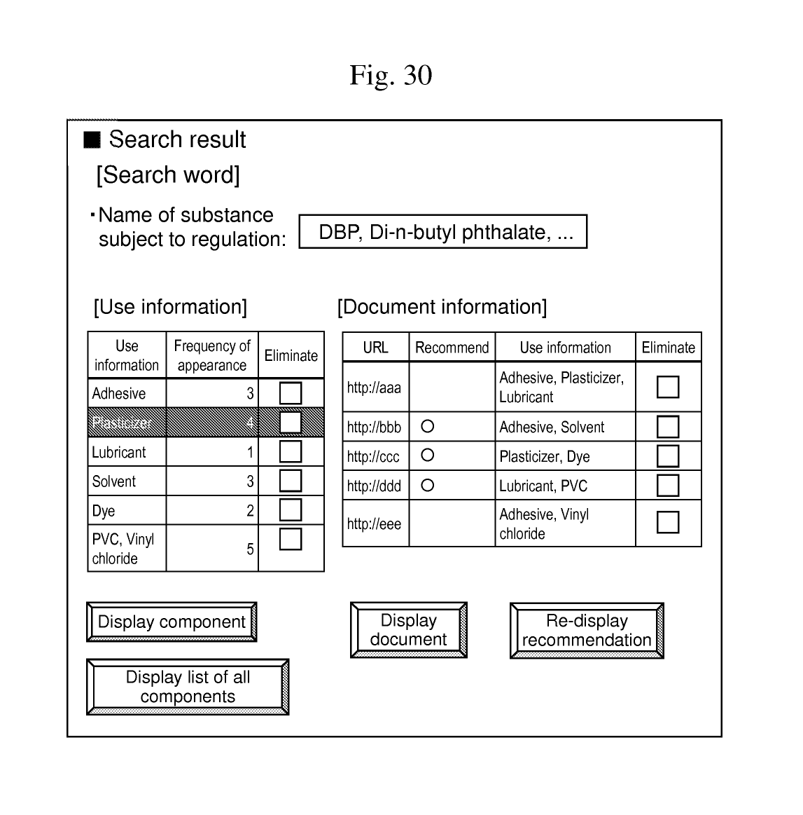

In the case of the present embodiment, the display control unit 325 displays an output screen shown in FIG. 30, for example. In the output screen shown in FIG. 30, a “frequency of appearance” field which was not present in the output screen shown in FIG. 23 is added to the use information. The other display fields and buttons are the same as those shown in FIG. 23. By displaying the frequency of appearance, it becomes easy to confirm the use information that appears in a large number of documents.

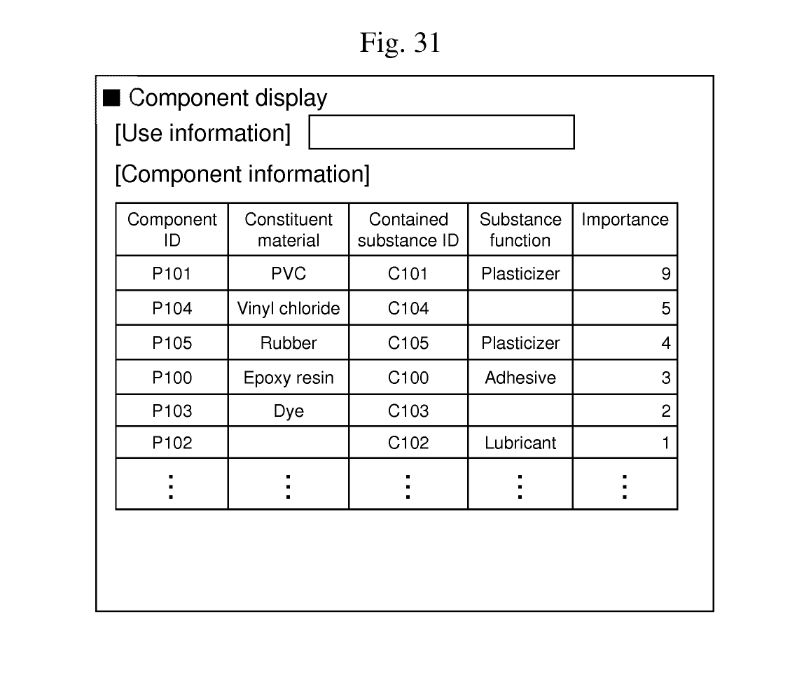

In the output screen shown in FIG. 30, when the user selects one row from the use information field and clicks the “Display component” button, the display control unit 325 causes the input/output unit 100 to display the screen shown in FIG. 24, for example. The method of displaying the screen is similar to Embodiment 2 and therefore its description will be omitted. In the output screen shown in FIG. 30, when the user clicks the “Display all component lists” button, the display control unit 325 causes the input/output unit 100 to display a screen shown in FIG. 31, for example. The screen shown in FIG. 31 displays the component information having all of the component IDs present in the by-use component information 225 shown in FIG. 22, and the importance of each component ID present in the component importance information 226. The display of the importance distinguishes the present embodiment from the screen of Embodiment 2 (FIG. 25). In FIG. 31, the display of the component ID is rearranged according to the importance.

### Conclusion

The investigation object document recommendation system 10 according to the present embodiment can attach high importance to the use information with high degree of certainty of appearing in a larger number of documents, and to present the list of the components having high probability of containing the substance subject to regulation which is rearranged by importance, in addition to providing the effects of Embodiments 1 and 2. Thus, the user can perform investigation and examination efficiently from components with higher risk.

### Other Embodiments

The present invention is not limited to the foregoing embodiments, and may include various modifications. For example, a part of one embodiment may be substituted by the configuration of another embodiment, or the configuration of the other embodiment may be added to the configuration of the one embodiment. With respect to a part of the configuration of each embodiment, addition, deletion, or substitution of another configuration may be made.

For example, the information of the frequency of appearance counted by use word as described with reference to Embodiment 3 may be used in the process of selecting the N combinations of documents in S140. For example, when there is a use word with the frequency of appearance “1”, it may be considered that the document is an indispensable document for selecting N combinations. Thus, by determining in advance a document combination that always includes a set of documents corresponding to the frequency of appearance “1”, the computation load and time before the document combination that exhausts all of the use information is discovered can be decreased.

In the foregoing embodiments, the N document combinations are selected by round-robin system. However, with respect to a document that completely corresponds, in terms of the combination of the appearing use words, to one of the documents constituting the combination for which the exhaustion determination has been completed in S150, a mechanism of eliminating the corresponding document from the combination object in S140 may be adopted. This is because, in this case, even if a document providing the combination is modified to another document, the use word exhaustiveness is not satisfied. The greater the number of the documents that completely correspond in the appearing use words, the more the number of document combinations created in S140 can be decreased, whereby the recommended documents can be efficiently searched for.

In the screen of FIG. 16, the recommend field is provided to all of the documents acquired in S100, enabling the determination as to whether the documents constitute the recommended documents on the screen. However, only the information about the recommended documents may be displayed on the screen.

In the screen of FIG. 16, the documents acquired in S100 and the recommended documents are presented by URL. However, a function may be provided whereby only the use description range extracted in S110 is displayed on the screen. Preferably, the user may be enabled to designate the switching between the screen displaying only the use description range and the screen displaying the entire documents.

In the screen of FIG. 31, the content is displayed where the article IDs with higher importance are rearranged to be positioned at the upper-levels of the screen. However, the rearrangement by importance may not necessarily be required.

In the foregoing embodiments, in the process of S140, the number of the investigation object documents (N) is sequentially increased from 1, and the determination process is exited at the point in time of finding the document combination satisfying the exhaustion condition. However, a mechanism may be adopted whereby document combinations satisfying the exhaustion condition are detected in the range of all or a predetermined number of documents, and one of the combinations with a minimum number of documents is determined as the recommended documents.

The configurations, functions, processing units, process means and the like may be partly or entirely realized in the form of hardware, such as an integrated circuit.

### REFERENCE SIGNS LIST

10 Investigation object document recommendation system
100 Input/output unit
200 Storage unit
210 Input information
211 Use word dictionary information
212 Contained-in-component substance information
220 Output information
221 Search word information
222 Use information
223 Document information
224 By-document use information
225 By-use component information
226 Component importance information
300 Operating unit
310 Memory unit
320 Operating processing unit
321 Document acquisition unit
322 Use description range extraction unit
323 Use information extraction unit
324 Recommended document determination unit
325 Display control unit
326 Component extraction unit
400 Web

1. An investigation object document recommendation system comprising:
an input/output unit that acquires data necessary for a process and that displays a result of processing of the data;
a storage unit including use word dictionary information for managing a keyword regarding a use of a substance subject to regulation; and
an operating unit that acquires document information from a network based on a search word regarding the substance subject to regulation that is input via the input/output unit, and that detects use information of the substance subject to regulation and a document combination that exhausts the use information,
wherein:
the operating unit includes
a document acquisition unit that acquires the document information from the Web based on the search word,
a use description range extraction unit that extracts from the acquired document information a range in which the use of the substance subject to regulation is described as a use description range,
a use information extraction unit that, based on the use word dictionary information, extracts the use information regarding the substance subject to regulation from the use description range,
a recommended document determination unit that extracts, from all of the documents acquired by the document acquisition unit, a set of documents providing a combination of a minimum number of documents that exhaust all of the use information extracted by the use information extraction unit, as recommended documents,
and a display control unit that displays the use information extracted by the use information extraction unit and the recommended documents on the input/output unit.

2. The investigation object document recommendation system according to claim 1, characterized in that
the recommended document determination unit executes a determination process as to, with respect to all combinations comprising N (natural number) documents selected by the document acquisition unit from the entire acquired documents, whether all of the use information extracted by the use information extraction unit is exhausted in ascending order from the combination of N=1, and extracts a set of documents at a point in time of discovery of the document combination that exhausts all of the use information as the recommended documents.

3. The investigation object document recommendation system according to claim 1, characterized in that
the display control unit displays on the input/output unit a screen that includes the document information of the entire documents acquired by the document acquisition unit, and a display showing the documents providing the combination of the minimum number of documents exhausting all of the use information.

4. The investigation object document recommendation system according to claim 1, characterized in that the display control unit displays the document information by URL.

5. The investigation object document recommendation system according to claim 1, characterized in that the display control unit displays the use description range extracted from the documents as the document information.

6. The investigation object document recommendation system according to claim 5, characterized in that the display control unit switches between the display of the use description range and the display of an entire text of the documents in accordance with a selection by a user.

7. The investigation object document recommendation system according to claim 1, characterized in that the display control unit displays frequency information in association with each item of the use information.

8. The investigation object document recommendation system according to claim 1, characterized in that the display screen of the use information and the recommended documents includes a check box for individually eliminating the use information and/or the document information, and a re-display recommendation button for causing the recommended document determination unit to execute re-extraction of the recommended documents under a condition where the use information and/or the document information that is checked in the check box is eliminated.

9. The investigation object document recommendation system according to claim 1, characterized in that:
the storage unit includes contained-in-component substance information for managing information of a chemical substance contained in a component procured from a supplier or independently manufactured and the use information; and
the operating unit includes a component extraction unit that searches the contained-in-component substance information based on the use information extracted by the use information extraction unit, and that extracts a component containing a relevant chemical substance.

10. The investigation object document recommendation system according to claim 9, characterized in that the display control unit displays a list of the extracted components on the input/output unit.

11. The investigation object document recommendation system according to claim 9, characterized in that:
the use information extraction unit counts the frequency of appearance of each item of the use information with respect to all of the documents acquired by the document acquisition unit;
the component extraction unit extracts the relevant component by searching the contained-in-component substance information based on the use information extracted by the use information extraction unit, and computes component importance information in accordance with the frequency of appearance of the use information; and
the display control unit displays the component related to the use information together with the component importance information.

12. The investigation object document recommendation system according to claim 11, characterized in that the display control unit rearranges the components related to the use information in order of magnitude of the component importance information when displaying the components.

13. A program for causing a computer mounted on an investigation object document recommendation system including an input/output unit that acquires data necessary for a process and that displays a result of processing of the data; a storage unit including use word dictionary information for managing a keyword regarding a use of a substance subject to regulation; and an operating unit that acquires document information from a network based on a search word regarding the substance subject to regulation that is input via the input/output unit, and that detects use information of the substance subject to regulation and a document combination that exhausts the use information to function as:
a document acquisition unit that acquires the document information from the Web based on the search word;
a use description range extraction unit that extracts from the acquired document information a range in which the use of the substance subject to regulation is described as a use description range;
a use information extraction unit that, based on the use word dictionary information, extracts the use information regarding the substance subject to regulation from the use description range;
a recommended document determination unit that extracts from all of the documents acquired by the document acquisition unit, a set of documents providing a combination of a minimum number of documents that exhaust all of the use information extracted by the use information extraction unit, as recommended documents; and
a display control unit that displays the use information extracted by the use information extraction unit and the recommended documents on the input/output unit.

14. An investigation object document recommending method executed by an investigation object document recommendation system including an input/output unit that acquires data necessary for a process and that displays a result of processing of the data; a storage unit including use word dictionary information for managing a keyword regarding a use of a substance subject to regulation; and an operating unit that acquires document information from a network based on a search word regarding the substance subject to regulation that is input via the input/output unit, and that detects use information of the substance subject to regulation and a document combination that exhausts the use information,
the method comprising:
a first process of the operating unit acquiring the document information from the Web based on the search word;
a second process of the operating unit extracting from the acquired document information a range in which the use of the substance subject to regulation is described as a use description range;
a third process of the operating unit, based on the use word dictionary information, extracting the use information regarding the substance subject to regulation from the use description range;
a fourth process of the operating unit extracting from all of the documents acquired by the document acquisition unit, a set of documents providing a combination of a minimum number of documents that exhaust all of the use information extracted by the use information extraction unit, as recommended documents; and
a fifth process of the operating unit displaying the use information extracted by the use information extraction unit and the recommended documents on the input/output unit.
